(19) United States
(12) Patent Application Publication
(10) Pub. No.: US 2026/0223008 A1
(43) Pub. Date: Jul. 30, 2026

(54) METHODS AND APPARATUSES FOR SRS POWER HEADROOM REPORT

(71) Applicant: Lenovo (Beijing) Limited, Beijing (CN)

(72) Inventors: Yi Zhang, Beijing (CN); Chenxi Zhu, Fairfax, VA (US); Wei Ling, Beijing (CN); Bingchao Liu, Beijing (CN); Lingling Xiao, Beijing (CN)

(73) Assignee: Lenovo (Beijing) Limited, Beijing (CN)

(21) Appl. No.: 19/148,554

(22) PCT Filed: Jan. 17, 2023
(86) PCT No.: PCT/CN2023/072628

§ 371 Date: Jul. 16, 2025

(51) Int. Cl. H04W 52/24; H04W 52/14; H04W 52/36

(52) U.S. Cl. CPC H04W 52/242; H04W 52/146; H04W 52/365

(57) ABSTRACT

Embodiments of the present disclosure relate to methods and apparatuses for sounding reference signal (SRS) power headroom report (PHR). According to an embodiment of the present disclosure, a user equipment (UE) can include: a transceiver that: receives a configuration for SRS power control, wherein the configuration indicates one of: a single SRS power control parameter set for an SRS resource set, wherein the single SRS power control parameter set includes multiple downlink (DL) pathloss reference reference signals (RSs); or multiple SRS power control parameter sets for the SRS resource set, wherein each of the multiple SRS power control parameter sets is associated with a corresponding DL pathloss reference RS in the multiple DL pathloss reference RSs; and transmits one or more PHRs based on the configuration; and a processor that is coupled with the transceiver.

### TECHNICAL FIELD

Embodiments of the present application generally relate to wireless communication technologies, and especially to methods and apparatuses for sounding reference signal (SRS) power headroom report (PHR).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, an SRS PHR may be used to report a difference between the nominal UE maximum transmit power and the estimated power for SRS transmission per activated serving cell to a base station (BS), such that the BS may perform power control for SRS transmission based on the SRS PHR. Currently, details regarding how to determine, report, and trigger the SRS PHR need to be further discussed for, e.g., coherent joint transmission (CJT) scenarios.

### SUMMARY OF THE APPLICATION

Embodiments of the present application at least provide technical solutions for SRS PHR.

According to some embodiments of the present application, a user equipment (UE) may include: a transceiver that: receives a configuration for SRS power control, wherein the configuration indicates one of: a single SRS power control parameter set for an SRS resource set, wherein the single SRS power control parameter set includes multiple downlink (DL) pathloss reference reference signals (RSS); or multiple SRS power control parameter sets for the SRS resource set, wherein each of the multiple SRS power control parameter sets is associated with a corresponding DL pathloss reference RS in the multiple DL pathloss reference RSs; and transmits one or more PHRs based on the configuration; and a processor that is coupled with the transceiver.

In some embodiments of the present application, the single SRS power control parameter set further includes at least one of: (1) either a common alpha value which is a common pathloss compensation factor for the multiple DL pathloss reference RSs or multiple alpha values, wherein each alpha value in the multiple alpha values is a pathloss compensation factor associated with a corresponding DL pathloss reference RS in the multiple DL pathloss reference RSs; or (2) multiple gamma values, wherein the multiple gamma values are weight coefficients for combining multiple pathloss estimates, and each gamma value in the multiple gamma values is associated with a corresponding pathloss estimate in the multiple pathloss estimates which is determined based on a corresponding DL pathloss reference RS in the multiple DL pathloss reference RSs.

In some embodiments of the present application, the transceiver transmits a single PHR indicating a power headroom determined by a transmission power of an actual SRS transmission, and the transmission power is determined based on a weighted combination of the multiple pathloss estimates obtained by using the at least one of (1) either the common alpha value or the multiple alpha values or (2) the multiple gamma values.

In some embodiments of the present application, the transceiver transmits a single PHR indicating a power headroom determined by a transmission power of a reference SRS transmission, and the transmission power is determined based on an equally weighted combination of the multiple pathloss estimates obtained by using (1) either the common alpha value or the multiple alpha values and (2) a fixed weight coefficient.

In some embodiments of the present application, the transceiver transmits a single PHR indicating a power headroom determined by a transmission power of a reference SRS transmission, and the transmission power is determined based on a maximum pathloss estimate among the multiple pathloss estimates, or determined based on a pathloss estimate calculated based on a fixed DL pathloss reference RS in the multiple DL pathloss reference RSs.

In some embodiments of the present application, the transceiver transmits a single PHR indicating a power headroom determined by a transmission power of a reference SRS transmission, and the transmission power is determined based on a weighted combination of the multiple pathloss estimates obtained by using (1) either the common alpha value or the multiple alpha values and (2) the multiple gamma values.

In some embodiments of the present application, the SRS resource set has an SRS resource set identity (ID) equal to 0.

In some embodiments of the present application, the SRS resource set has a lowest SRS resource set ID among SRS resource sets configured with multiple DL pathloss reference RSs.

In some embodiments of the present application, the transceiver transmits a single PHR indicating a power headroom determined by a transmission power of an actual SRS transmission or a reference SRS transmission, and the transmission power is determined based on a pathloss estimate calculated based on a DL pathloss reference RS associated with an SRS power control parameter set within the multiple SRS power control parameter sets.

In some embodiments of the present application, the SRS power control parameter set has a fixed index within the multiple SRS power control parameter sets.

In some embodiments of the present application, the SRS power control parameter set is a power control parameter set associated with a first actual SRS transmission if there is actual SRS transmission(s) after the PHR is triggered.

In some embodiments of the present application, the SRS power control parameter set is a power control parameter set selected by the UE, and the transceiver further transmits an indication indicating the selected power control parameter set to a BS.

In some embodiments of the present application, the transceiver transmits multiple PHRs, each PHR of the multiple PHRs indicates a power headroom determined by a corresponding transmission power of an actual SRS transmission or a reference SRS transmission, and the corresponding transmission power is determined based on a corresponding pathloss estimate which is calculated based on a corresponding DL pathloss reference RS in the multiple DL pathloss reference RSs.

In some embodiments of the present application, the transceiver transmits two PHRs, wherein one PHR of the two PHRs indicates a first power headroom determined by a first transmission power of an actual SRS transmission or a reference SRS transmission which is determined based on a weighted combination of the multiple pathloss estimates obtained by using the at least one of (1) either the common alpha value or the multiple alpha values or (2) the multiple gamma values, and wherein the other PHR of the two PHRs indicates a second power headroom determined by a second transmission power of an actual SRS transmission or a reference SRS transmission which is determined based on a pathloss estimate calculated based on a selected DL pathloss reference RS in the multiple DL pathloss reference RSs.

In some embodiments of the present application, the weighted combination of the multiple pathloss estimates is an equally weighted combination of the multiple pathloss estimates obtained by using (1) either the common alpha value or the multiple alpha values and (2) a fixed weight coefficient.

In some embodiments of the present application, the selected DL pathloss reference RS is a first configured DL pathloss reference RS among the multiple DL pathloss reference RSs, or is associated with a largest pathloss estimate among the multiple DL pathloss reference RSs.

In some embodiments of the present application, the processor selects one or more power headrooms from M power headrooms, M is the number of the multiple SRS power control parameter sets, each power headroom of the M power headrooms is determined by a corresponding transmission power of an actual SRS transmission or a reference SRS transmission, and the corresponding transmission power is determined based on a corresponding pathloss estimate which is associated with a corresponding SRS power control parameter set in the multiple SRS power control parameter sets; wherein each PHR of the one or more PHRs indicates a corresponding power headroom in the one or more power headrooms; and wherein the transceiver further transmits an indication indicating index(es) of the one or more PHRs to a BS.

In some embodiments of the present application, the transceiver further receives from the BS an indication indicating a maximum number of PHRs to be transmitted in once reporting.

In some embodiments of the present application, the transceiver transmits M PHRs, M is the number of the multiple SRS power control parameter sets, each PHR of the M PHRs indicates a corresponding power headroom determined by a corresponding transmission power of an actual SRS transmission or a reference SRS transmission, and the corresponding transmission power is determined based on a corresponding pathloss estimate which is associated with a corresponding SRS power control parameter set in the multiple SRS power control parameter sets, wherein M is a pre-defined value or configured by a BS.

In some embodiments of the present application, the transceiver transmits multiple PHRs, and each of PHR(s) other than a first PHR in the multiple PHRs indicates a differential quantized power headroom relative to a power headroom indicated by the first PHR.

In some embodiments of the present application, in the case that the configuration indicates the single SRS power control parameter set, the processor triggers transmission of the one or more PHRs when a PHR prohibit timer expires or has expired and a weighted combination of multiple pathloss estimates is changed more than a trigger threshold, wherein each pathloss estimate in the multiple pathloss estimates is calculated based on a corresponding DL pathloss reference RS in the multiple DL pathloss reference RSs.

In some embodiments of the present application, in the case that the configuration indicates the single SRS power control parameter set, the processor triggers transmission of the one or more PHRs when a PHR prohibit timer expires or has expired and a maximum pathloss estimate among multiple pathloss estimates is changed more than a trigger threshold, wherein each pathloss estimate in the multiple pathloss estimates is calculated based on a corresponding DL pathloss reference RS in the multiple DL pathloss reference RSs.

In some embodiments of the present application, in the case that the configuration indicates the single SRS power control parameter set, the processor triggers transmission of the one or more PHRs when a PHR prohibit timer expires or has expired and a pathloss estimate calculated based on a DL pathloss reference RS in the multiple DL pathloss reference RSs is changed more than a trigger threshold associated with the DL pathloss reference RS.

In some embodiments of the present application, each of the multiple DL pathloss reference RSs is associated with a same or different trigger threshold.

In some embodiments of the present application, in the case that the configuration indicates the multiple SRS power control parameter sets, the processor triggers transmission of the one or more PHRs when a PHR prohibit timer expires or has expired and a pathloss estimate determined based on a DL pathloss reference RS associated with an SRS power control parameter set within the multiple SRS power control parameter sets is changed more than a trigger threshold associated with the SRS power control parameter set.

In some embodiments of the present application, each of the multiple SRS power control parameter sets is associated with a same or different trigger threshold.

In some embodiments of the present application, in the case that the configuration indicates the multiple SRS power control parameter sets, the processor triggers transmission of a single PHR when a PHR prohibit timer expires or has expired and a pathloss estimate determined based on a DL pathloss reference RS associated with an SRS power control parameter set with a fixed index within the multiple SRS power control parameter sets is changed more than a trigger threshold.

According to some embodiments of the present application, a BS may include: a transceiver that: transmits, to a UE, a configuration for SRS power control, wherein the configuration indicates one of: a single SRS power control parameter set for an SRS resource set, wherein the single SRS power control parameter set includes multiple DL pathloss reference RSs; or multiple SRS power control parameter sets for the SRS resource set, wherein each of the multiple SRS power control parameter sets is associated with a corresponding DL pathloss reference RS in the multiple DL pathloss reference RSs; and receives, from the UE, one or more PHRs based on the configuration; and a processor that is coupled with the transceiver.

In some embodiments of the present application, the single SRS power control parameter set further includes at least one of: (1) either a common alpha value which is a common pathloss compensation factor for the multiple DL pathloss reference RSs or multiple alpha values, wherein each alpha value in the multiple alpha values is a pathloss compensation factor associated with a corresponding DL pathloss reference RS in the multiple DL pathloss reference RSs; or (2) multiple gamma values, wherein the multiple gamma values are weight coefficients for combining multiple pathloss estimates, and each gamma value in the multiple gamma values is associated with a corresponding pathloss estimate in the multiple pathloss estimates which is determined based on a corresponding DL pathloss reference RS in the multiple DL pathloss reference RSs.

In some embodiments of the present application, the transceiver receives a single PHR indicating a power headroom determined by a transmission power of an actual SRS transmission, and the transmission power is determined based on a weighted combination of the multiple pathloss estimates obtained by using the at least one of (1) either the common alpha value or the multiple alpha values or (2) the multiple gamma values.

In some embodiments of the present application, the transceiver receives a single PHR indicating a power headroom determined by a transmission power of a reference SRS transmission, and the transmission power is determined based on an equally weighted combination of the multiple pathloss estimates obtained by using (1) either the common alpha value or the multiple alpha values and (2) a fixed weight coefficient.

In some embodiments of the present application, the transceiver receives a single PHR indicating a power headroom determined by a transmission power of a reference SRS transmission, and the transmission power is determined based on a maximum pathloss estimate among the multiple pathloss estimates, or determined based on a pathloss estimate calculated based on a fixed DL pathloss reference RS in the multiple DL pathloss reference RSs.

In some embodiments of the present application, the transceiver receives a single PHR indicating a power headroom determined by a transmission power of a reference SRS transmission, and the transmission power is determined based on a weighted combination of the multiple pathloss estimates obtained by using (1) either the common alpha value or the multiple alpha values and (2) the multiple gamma values.

In some embodiments of the present application, the SRS resource set has an SRS resource set ID equal to 0.

In some embodiments of the present application, the SRS resource set has a lowest SRS resource set ID among SRS resource sets configured with multiple DL pathloss reference RSs.

In some embodiments of the present application, the transceiver receives a single PHR indicating a power headroom determined by a transmission power of an actual SRS transmission or a reference SRS transmission, and the transmission power is determined based on a pathloss estimate calculated based on a DL pathloss reference RS associated with an SRS power control parameter set within the multiple SRS power control parameter sets.

In some embodiments of the present application, the SRS power control parameter set has a fixed index within the multiple SRS power control parameter sets.

In some embodiments of the present application, the SRS power control parameter set is a power control parameter set associated with a first actual SRS transmission if there is actual SRS transmission(s) after the PHR is triggered.

In some embodiments of the present application, the SRS power control parameter set is a power control parameter set selected by the UE, and the transceiver further receives, from the UE, an indication indicating the selected power control parameter set.

In some embodiments of the present application, the transceiver receives multiple PHRs, each PHR of the multiple PHRs indicates a power headroom determined by a corresponding transmission power of an actual SRS transmission or a reference SRS transmission, and the corresponding transmission power is determined based on a corresponding pathloss estimate which is calculated based on a corresponding DL pathloss reference RS in the multiple DL pathloss reference RSs.

In some embodiments of the present application, the transceiver receives two PHRs, wherein one PHR of the two PHRs indicates a first power headroom determined by a first transmission power of an actual SRS transmission or a reference SRS transmission which is determined based on a weighted combination of the multiple pathloss estimates obtained by using the at least one of (1) either the common alpha value or the multiple alpha values or (2) the multiple gamma values, and wherein the other PHR of the two PHRs indicates a second power headroom determined by a second transmission power of an actual SRS transmission or a reference SRS transmission which is determined based on a pathloss estimate calculated based on a selected DL pathloss reference RS in the multiple DL pathloss reference RSs.

In some embodiments of the present application, the weighted combination of the multiple pathloss estimates is an equally weighted combination of the multiple pathloss estimates obtained by using (1) either the common alpha value or the multiple alpha values and (2) a fixed weight coefficient.

In some embodiments of the present application, the selected DL pathloss reference RS is a first configured DL pathloss reference RS among the multiple DL pathloss reference RSs, or is associated with a largest pathloss estimate among the multiple DL pathloss reference RSs.

In some embodiments of the present application, each PHR of the one or more PHRs indicates a corresponding power headroom in one or more power headrooms selected by the UE from M power headrooms, M is the number of the multiple SRS power control parameter sets, each power headroom of the M power headrooms is determined by a corresponding transmission power of an actual SRS transmission or a reference SRS transmission, and the corresponding transmission power is determined based on a corresponding pathloss estimate which is associated with a corresponding SRS power control parameter set in the multiple SRS power control parameter sets; and wherein the transceiver further receives an indication indicating index(es) of the one or more PHRs from the UE.

In some embodiments of the present application, the transceiver further transmits to the UE an indication indicating a maximum number of PHRs to be transmitted in once reporting.

In some embodiments of the present application, the transceiver receives M PHRs, M is the number of the multiple SRS power control parameter sets, each PHR of the M PHRs indicates a corresponding power headroom determined by a corresponding transmission power of an actual SRS transmission or a reference SRS transmission, and the corresponding transmission power is determined based on a corresponding pathloss estimate which is associated with a corresponding SRS power control parameter set in the multiple SRS power control parameter sets, wherein M is a pre-defined value or configured by the BS.

In some embodiments of the present application, the transceiver receives multiple PHRs, and each of PHR(s) other than a first PHR in the multiple PHRs indicates a differential quantized power headroom relative to a power headroom indicated by the first PHR.

In some embodiments of the present application, in the case that the configuration indicates the single SRS power control parameter set, transmission of the one or more PHRs is triggered when a PHR prohibit timer expires or has expired and a weighted combination of multiple pathloss estimates is changed more than a trigger threshold, wherein each pathloss estimate in the multiple pathloss estimates is calculated based on a corresponding DL pathloss reference RS in the multiple DL pathloss reference RSs.

In some embodiments of the present application, in the case that the configuration indicates the single SRS power control parameter set, transmission of the one or more PHRs is triggered when a PHR prohibit timer expires or has expired and a maximum pathloss estimate among multiple pathloss estimates is changed more than a trigger threshold, wherein each pathloss estimate in the multiple pathloss estimates is calculated based on a corresponding DL pathloss reference RS in the multiple DL pathloss reference RSs.

In some embodiments of the present application, in the case that the configuration indicates the single SRS power control parameter set, transmission of the one or more PHRs is triggered when a PHR prohibit timer expires or has expired and a pathloss estimate calculated based on a DL pathloss reference RS in the multiple DL pathloss reference RSs is changed more than a trigger threshold associated with the DL pathloss reference RS.

In some embodiments of the present application, each of the multiple DL pathloss reference RSs is associated with a same or different trigger threshold.

In some embodiments of the present application, in the case that the configuration indicates the multiple SRS power control parameter sets, transmission of the one or more PHRs is triggered when a PHR prohibit timer expires or has expired and a pathloss estimate determined based on a DL pathloss reference RS associated with an SRS power control parameter set within the multiple SRS power control parameter sets is changed more than a trigger threshold associated with the SRS power control parameter set.

In some embodiments of the present application, each of the multiple SRS power control parameter sets is associated with a same or different trigger threshold.

In some embodiments of the present application, in the case that the configuration indicates the multiple SRS power control parameter sets, transmission of a single PHR is triggered when a PHR prohibit timer expires or has expired and a pathloss estimate determined based on a DL pathloss reference RS associated with an SRS power control parameter set with a fixed index within the multiple SRS power control parameter sets is changed more than a trigger threshold.

According to some embodiments of the present application, a method performed by a UE may include: receiving a configuration for SRS power control, wherein the configuration indicates one of: a single SRS power control parameter set for an SRS resource set, wherein the single SRS power control parameter set includes multiple DL pathloss reference RSs; or multiple SRS power control parameter sets for the SRS resource set, wherein each of the multiple SRS power control parameter sets is associated with a corresponding DL pathloss reference RS in the multiple DL pathloss reference RSs; and transmitting one or more PHRs based on the configuration.

According to some embodiments of the present application, a method performed by a BS may include: transmitting, to a UE, a configuration for SRS power control, wherein the configuration indicates one of: a single SRS power control parameter set for an SRS resource set, wherein the single SRS power control parameter set includes multiple DL pathloss reference RSs; or multiple SRS power control parameter sets for the SRS resource set, wherein each of the multiple SRS power control parameter sets is associated with a corresponding DL pathloss reference RS in the multiple DL pathloss reference RSs; and receiving, from the UE, one or more PHRs based on the configuration.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 is a flow chart illustrating an exemplary method for SRS PHR according to some embodiments of the present application;

FIGS. 3 and 4 illustrate exemplary SRS transmission and SRS PHR reporting according to some embodiments of the present application;

FIG. 5 is a flow chart illustrating an exemplary method for SRS PHR according to some other embodiments of the present application; and

FIG. 6 illustrates a simplified block diagram of an exemplary apparatus for SRS PHR according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) LTE and LTE-advanced, 3GPP 5G NR, 5G-advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

A wireless communication system generally includes one or more BSs and one or more UEs. Furthermore, a BS may be configured with one transmit-receive point (TRP) (or panel) or more TRPs (or panels). A TRP can act like a small BS. The TRPs can communicate with each other by a backhaul link. Such backhaul link may be an ideal backhaul link or a non-ideal backhaul link. Latency of the ideal backhaul link may be deemed as zero, and latency of the non-ideal backhaul link may be tens of milliseconds and much larger, e.g., on the order of tens of milliseconds, than that of the ideal backhaul link.

In a wireless communication system, one single TRP can be used to serve one or more UEs under control of a BS. In different scenarios, TRP may be called in different terms. Persons skilled in the art should understand that as the 3GPP and the communication technology develop, the terminologies recited in the specification may change, which should not affect the scope of the present application. It should be understood that the TRP(s) (or panel(s)) configured for the BS may be transparent to a UE.

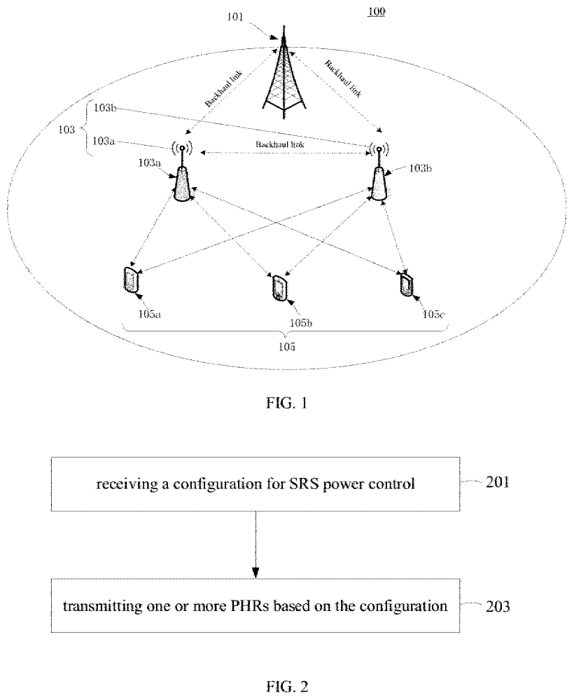

FIG. 1 is a schematic diagram illustrating an exemplary wireless communication system 100 according to some embodiments of the present application.

Referring to FIG. 1, the wireless communication system 100 can include a BS 101, TRPs 103 (e.g., TRP 103a and TRP 103b), and UEs 105 (e.g., UE 105a, UE 105b, and UE 105c). Although only one BS 101, two TRPs 103 and three UEs 105 are shown for simplicity, it should be noted that the wireless communication system 100 may include more or less communication device(s), apparatus, or node(s) in accordance with some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced or evolved node B (eNB), a generalized node B (gNB), a home node-B, a relay node, or a device, or described using other terminology used in the art. The BS 101 is generally part of a radio access network that may include a controller communicably coupled to the BS 101.

The TRPs 103, for example, the TRP 103a and the TRP 103b, can communicate with the BS 101 via, for example, a backhaul link. Each of TRPs 103 can serve some or all of the UEs 105. As shown in FIG. 1, the TRP 103a can serve some mobile stations (which include the UE 105a, the UE 105b, and the UE 105c) within a serving area or region (e.g., a cell or a cell sector). The TRP 103b can serve some mobile stations (which include the UE 105a, the UE 105b, and the UE 105c) within a serving area or region (e.g., a cell or a cell sector). In some other embodiments, the TRP 103a and the TRP 103b may serve different UEs. The TRP 103a and the TRP 103b can communicate with each other via, for example, a backhaul link.

According to some embodiments of the present application, the UE(s) 105 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some embodiments of the present application, the UE(s) 105 may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present application, the UE(s) 105 may include wearable devices, such as smart watches, fitness bands, optical head-mounted displays, or the like.

Moreover, the UE(s) 105 may be referred to as a subscriber unit, a mobile, a mobile station, a user, a terminal, a mobile terminal, a wireless terminal, a fixed terminal, a subscriber station, a user terminal, or a device, or described using other terminology used in the art.

In 3GPP Release 16 (Rel-16) or Release 17 (Rel-16), features for facilitating multi-TRP deployments have been introduced focusing on non-coherent joint transmission (NC-JT). In 3GPP Release 18 (Rel-18), it is important to identify and specify necessary enhancements for both downlink and uplink multiple input multiple output (MIMO) for facilitating the use of large antenna array, not only for frequency range 1 (FR1) (e.g., 450 MHz-6 GHz) but also for frequency range 2 (FR2) (e.g., 24.25 GHz-52.6 GHz) to fulfil the request for evolution of NR deployments.

CJT may improve coverage and cell average throughput and cell edge throughput in commercial deployments with high-performance backhaul and synchronization, and provide enhancement on channel state information (CSI) acquisition for frequency division duplex (FDD) and time division duplex (TDD), which can be beneficial in expanding the utility of multi-TRP deployments. Accordingly, In Rel-18, CJT may be further studied.

In CJT, same information may be transmitted coherently from multiple TRPs. For a TDD system, SRS may be used to obtain DL CSI by exploiting channel reciprocity. SRS based DL CSI acquisition scheme has the benefit of lower CSI feedback overhead and higher CSI precision, compared with quantized precoding matrix indicator (PMI) feedback.

However, for cell-edge UEs, the uplink signal to interference plus noise ratio (SINR) and channel quality may be too low to perform SRS-based channel measurement with sufficient resolution, especially for power-limited UEs. Enhanced SRS power control schemes may be proposed to deal with the inter-TRP cross-SRS interference. For example, the enhanced SRS power control schemes may include option 1 and option 2 as follows.

For option 1, each transmission occasion of an SRS resource is towards multiple TRPs and the same power control process is applied for all SRS resources of an SRS resource set where the power control process is based on one Po value and one closed loop state and jointly on more than one DL pathloss reference RS and/or more than one alpha value.

For option 2, different transmission occasions of an SRS resource can be towards different TRPs. Moreover, there may be more than one power control processes for an SRS resource set, and each power control process is based on a different uplink (UL) power control parameter set (e.g., including Po value, alpha value, and closed loop state) associated with a different DL pathloss reference RS.

However, SRS based PHR (also referred to as SRS PHR, or Type 3 PHR) for CJT has not been discussed yet. For example, SRS PHR determining schemes, SRS PHR reporting schemes, and SRS PHR triggering schemes for CJT have not been discussed at all.

Given the above, embodiments of the present application propose solutions for SRS PHR. For example, embodiments of the present application propose solutions regarding SRS PHR determining, SRS PHR reporting, and SRS PHR triggering, e.g., for CJT. More details on embodiments of the present application will be described in the following text in combination with the appended drawings.

According to some embodiments of the present application, SRS may be transmitted on one carrier to achieve multiple DL CSI corresponding to multiple TRPs but there is no configured physical uplink shared channel (PUSCH) or physical uplink control channel (PUCCH) on this carrier. SRS power headroom may be referred to as Type 3 power headroom, which is the difference between the nominal UE maximum transmit power and the estimated power for SRS transmission per activated serving cell. Solutions regarding SRS PHR determining, SRS PHR reporting, and SRS PHR triggering may be based on the aforementioned option 1 and option 2. More details will be described in the following text in combination with the appended drawings.

FIG. 2 is a flow chart illustrating an exemplary method for SRS PHR according to some embodiments of the present application. The method illustrated in FIG. 2 may be implemented by a UE (e.g., UE 105a, UE 105b or UE 105c as shown in FIG. 1) or any other device having similar functions.

In the exemplary method shown in FIG. 2, in step 201, the UE may receive configuration for SRS power control from, e.g., a BS (e.g., BS 101 as shown in FIG. 1). In step 203, the UE may transmit one or more PHRs based on the configuration. The configuration may include different information in different solutions, which will be described in detail below.

### Solution 1

Solution 1 is based on the aforementioned option 1. In solution 1, the configuration received in step 201 may include one or more SRS power control parameter sets for one or more SRS resource sets, wherein each SRS power control parameter set of the one or more SRS power control parameter sets may be associated with a corresponding SRS resource set of the one or more SRS resource sets.

For simplicity, the following descriptions take an SRS resource set (e.g., denoted by qₛ) of the one or more SRS resource sets as an example. It is contemplated that the definitions regarding the SRS resource set may also apply to any other SRS resource sets.

For example, the configuration may indicate a single SRS power control parameter set for the SRS resource set qₛ. The single SRS power control parameter set may include multiple DL pathloss reference RSs, wherein a DL pathloss reference RS may be denoted by q_{d,m}, wherein m is an index of the DL pathloss reference RS and 0≤m≤M−1, wherein M is the total number of the multiple DL pathloss reference RSs.

In some embodiments of the present application, each DL pathloss reference RS may be associated with a corresponding TRP. In such embodiments, M is also the total number of TRPs, and m is also an index of a corresponding TRP.

In some embodiments, the single SRS power control parameter set may include one Po value and one closed loop state (e.g., denoted by h_{b,f,c}(i, l), wherein b represents an active UL bandwidth part (BWP), f represents a carrier, c represents a serving cell, i represents an SRS transmission occasion, and l represents a power control adjustment state index.

In some embodiments, the single SRS power control parameter set may further include at least one of:
(1) either a common alpha value (e.g., denoted by α_{SRS,b,f,c}(qₛ)) which is a common pathloss compensation factor for the multiple DL pathloss reference RSs or multiple alpha values (e.g., denoted by α_{SRS,b,f,c,m}(qₛ), wherein each alpha value in the multiple alpha values is a pathloss compensation factor associated with a corresponding DL pathloss reference RS (e.g., denoted by q_{d,m}) in the multiple DL pathloss reference RSs; or
(2) multiple gamma values (e.g., denoted by γ_{SRS,b,f,c,m}(qₛ)), wherein the multiple gamma values are weight coefficients for combining multiple pathloss estimates (e.g., denoted by PL_{b,f,c,m}(q_{d,m})), and each gamma value in the multiple gamma values is associated with a corresponding pathloss estimate in the multiple pathloss estimates which is determined based on a corresponding DL pathloss reference RS (e.g., denoted by q_{d,m}) in the multiple DL pathloss reference RSs.

Based on the above configuration, the UE may transmit one or more PHRs in step 203. Depending on the number of the PHR(s) transmitted by the UE, solution 1 may include embodiments 1-3.

### Embodiment 1

In embodiment 1, the UE transmits a single PHR indicating a power headroom. Depending on whether the power headroom indicated by the single PHR is determined by a transmission power of an actual SRS transmission or a transmission power of a reference SRS transmission, embodiment 1 may include embodiment 1-1 and embodiment 1-2.

### Embodiment 1-1

In embodiment 1-1, the power headroom indicated by the single PHR is determined by a transmission power of an actual SRS transmission.

In some embodiments, the transmission power may be determined based on a weighted combination of multiple pathloss estimates obtained by using the at least one of (1) either the common alpha value or the multiple alpha values or (2) the multiple gamma values included in the single SRS power control parameter set for an SRS resource set. Each pathloss estimate in the multiple pathloss estimates may be determined based on a corresponding DL pathloss reference RS in the multiple DL pathloss reference RSs included in the single SRS power control parameter set for the SRS resource set.

For example, the single SRS power control parameter set for an SRS resource set may include multiple DL pathloss reference RSs, multiple alpha values and multiple gamma values. In such example, the transmission power of an actual SRS transmission may be determined based on a weighted combination of the multiple pathloss estimates obtained by using the multiple alpha values and the multiple gamma values.

In such example, if the UE determines that a PHR for an activated serving cell is based on an actual SRS transmission, the UE is not configured for PUSCH transmissions on carrier f of serving cell c and the resource for the SRS transmission is in SRS resource set qₛ, then, for SRS transmission occasion i on active UL BWP b of the carrier f of the serving cell c, the power headroom (e.g., PH_{type3,b,f,c}(i, qₛ)) may be determined as:

$${PH}_{t ype 3 , b , f , c} ( i , {q}_{s} ) = {P}_{CMAX , f , c} ( i ) - \{ \begin{matrix}{P}_{O\_SRS , b , f , c} ( {q}_{s} ) + 10 {log}_{10} ( {2}^{μ} {M}_{SRS , b , f , c} ( i ) ) + \\ {\sum }_{m = 0}^{M - 1} {α}_{SRS , b , f , c , m} ( {q}_{s} ) \cdot {PL}_{b , f , c , m} ( {q}_{d , m} ) \cdot {γ}_{SRS , b , f , c , m} ( {q}_{s} ) + {h}_{b , f , c} ( i , l )\end{matrix} \} [ dBm ] \qquad ( 1 )$$

wherein P_{O_SRS,b,f,c}(qₛ) is the Po value included in the single SRS power control parameter set for the SRS resource set qₛ; h_{b,f,c}(i, l) is the close loop state included in the single SRS power control parameter set for the SRS resource set qₛ; P_{CMAX,f,c}(i), μ, and M_{SRS,b,f,c}(i) may have the same definitions as those specified in TS 38.213; q_{d,m} represents a DL pathloss reference RS, wherein m=0, 1, . . . , M−1 and M is the number of the multiple DL pathloss reference RSs; PL_{b,f,c,m}(q_{d,m}) is a pathloss estimate determined based on a corresponding DL pathloss reference RS q_{d,m}; α_{SRS,b,f,c,m}(qₛ) is an alpha value associated with a corresponding DL pathloss reference RS q_{d,m}, and γ_{SRS,b,f,c,m}(qₛ) is a gamma value associated with a pathloss estimate PL_{b,f,c,m}(q_{d,m}).

As another example, the single SRS power control parameter set for an SRS resource set may include multiple DL pathloss reference RSs, a common alpha value and multiple gamma values. In such example, the common alpha value may be the same as that defined in TS 38.213, e.g., denoted by α_{SRS,b,f,c}(qₛ). In such example, the transmission power of an actual SRS transmission may be determined based on a weighted combination of the multiple pathloss estimates obtained by using the common alpha value and the multiple gamma values.

In such example, if the UE determines that a PHR for an activated serving cell is based on an actual SRS transmission, the UE is not configured for PUSCH transmissions on carrier f of serving cell c and the resource for the SRS transmission is in SRS resource set qₛ, then, for SRS transmission occasion i on active UL BWP b of the carrier f of the serving cell c, the power headroom (e.g., PH_{type3,b,f,c}(i, qₛ)) may be determined as:

$${PH}_{type 3 , b , f , c} ( i , {q}_{s} ) = {P}_{CMAX , f , c} ( i ) - \{ \begin{matrix}{P}_{O\_SRS , b , f , c} ( {q}_{s} ) + 10 {log}_{10} ( {2}^{μ} {M}_{SRS , b , f , c} ( i ) ) + \\ {α}_{SRS , b , f , c} ( {q}_{s} ) {\sum }_{m = 0}^{M - 1} {PL}_{b , , f , c , m} ( {q}_{d , m} ) \cdot {γ}_{SRS , b , f , c , m} ( {q}_{s} ) + {h}_{b , f , c} ( i , l )\end{matrix} \} [ dBm ] \qquad ( 2 )$$

Parameters in formula (2) may have the same definitions as those in formula (1).

In some embodiments, the weighted combination of the multiple pathloss estimates may an equally weighted combination of the multiple pathloss estimates obtained by using (1) either the common alpha value or the multiple alpha values included in the single SRS power control parameter set for an SRS resource set and (2) a fixed weight coefficient.

For example, the single SRS power control parameter set for an SRS resource set may include multiple DL pathloss reference RSs and a common alpha value, e.g., denoted by α_{SRS,b,f,c}(qₛ). Then, the transmission power of an actual SRS transmission may be determined based on an equally weighted combination of the multiple pathloss estimates obtained by using the common alpha value and a fixed weight coefficient, e.g., 1 or 1/M.

In such example, if the UE determines that a PHR for an activated serving cell is based on an actual SRS transmission, the UE is not configured for PUSCH transmissions on carrier f of serving cell c and the resource for the SRS transmission is in SRS resource set qₛ, and the fixed weight coefficient is 1/M, then, for SRS transmission occasion i on active UL BWP b of the carrier f of the serving cell c, the power headroom (e.g., PH_{type3,b,f,c}(i, qₛ)) may be determined as:

$${PH}_{type 3 , b , f , c} ( i , {q}_{s} ) = {P}_{CMAX , f , c} ( i ) - \{ \begin{matrix}{P}_{O\_SRS , b , f , c} ( {q}_{s} ) + 10 {log}_{10} ( {2}^{μ} {M}_{SRS , b , f , c} ( i ) ) + \\ {α}_{SRS , b , f , c} ( {q}_{s} ) {\sum }_{m = 0}^{M - 1} {PL}_{b , , f , c , m} ( {q}_{d , m} ) / M ) + {h}_{b , f , c} ( i , l )\end{matrix} \} [ dBm ] \qquad ( 3 )$$

Parameters in formula (3) may have the same definitions as those in formula (2).

As another example, the single SRS power control parameter set for an SRS resource set may include multiple DL pathloss reference RSs and multiple alpha values. In some cases of such example, the transmission power of an actual SRS transmission may be determined based on an equally weighted combination of the multiple pathloss estimates obtained by using the multiple alpha values and a fixed weight coefficient, e.g., 1 or 1/M. In some cases of such example, a fixed weight coefficient may be merged into an alpha value. In such cases, the transmission power of an actual SRS transmission may be determined based on a weighted combination of the multiple pathloss estimates obtained by using the multiple alpha values. For example, the multiple alpha values may be selected from a set of candidate alpha values. In legacy, a set of candidate alpha values may be {0, 0.4, 0.5, 0.6, 0.7, 0.8, 0.9, 1}. By merging a fixed weight coefficient (e.g., ½ or ⅓), some additional candidate alpha values (e.g., 0.1, 0.2, 0.3) may be obtained from the above set of candidate alpha values (e.g., by multiplying the fixed weight coefficient). The additional candidate alpha values may be added to the above set to form a new set of candidate alpha values, from which the multiple alpha values may be selected.

In such example, if the UE determines that a PHR for an activated serving cell is based on an actual SRS transmission, the UE is not configured for PUSCH transmissions on carrier f of serving cell c and the resource for the SRS transmission is in SRS resource set qₛ, and the fixed weight coefficient is 1/M, then, for SRS transmission occasion i on active UL BWP b of the carrier f of the serving cell c, the power headroom (e.g., PH_{type3,b,f,c}(i, qₛ)) may be determined as:

$${PH}_{type 3 , b , f , c} ( i , {q}_{s} ) = {P}_{CMAX , f , c} ( i ) - \{ \begin{matrix}{P}_{O\_SRS , b , f , c} ( {q}_{s} ) + 10 {log}_{10} ( {2}^{μ} {M}_{SRS , b , f , c} ( i ) ) + \\ {\sum }_{m = 0}^{M - 1} {α}_{SRS , b , f , c , m} ( {q}_{s} ) \cdot {PL}_{b , f , c , m} ( {q}_{d , m} ) / M + {h}_{b , f , c} ( i , l )\end{matrix} \} [ dBm ] \qquad ( 4 )$$

Parameters in formula (4) may have the same definitions as those in formula (1).

In the above formulae, PL_{b,f,c,m}(q_{d,m}) is represented in dB value. In the following examples, PL_{b,f,c,m}(q_{d,m}) is represented in linear value.

For example, in the case that the single SRS power control parameter set for an SRS resource set includes multiple DL pathloss reference RSs, multiple alpha values and multiple gamma values, the power headroom (e.g., PH_{type3,b,f,c}(i, qₛ)) may be determined as:

$${PH}_{type 3 , b , f , c} ( i , {q}_{s} ) = {P}_{CMAX , f , c} ( i ) - \{ \begin{matrix}{P}_{O\_SRS , b , f , c} ( {q}_{s} ) + 10 {log}_{10} ( {2}^{μ} {M}_{SRS , b , f , c} ( i ) ) + \\ 10 \cdot {log}_{10} ( {\sum }_{m = 0}^{M - 1} {10}^{{α}_{SRS , b , f , c , m} ( {q}_{s} ) \cdot \frac{{PL}_{b , f , c , m} ( {q}_{d , m} )}{10}} \cdot {γ}_{SRS , b , f , c , m} ( {q}_{s} ) ) + {h}_{b , f , c} ( i , l )\end{matrix} \} [ dBm ] \qquad ( 5 )$$

Parameters in formula (5) may have the same definitions as those in formula (1), except that PL_{b,f,c,m}(q_{d,m}) is represented in linear value.

As another example, in the case that the single SRS power control parameter set for an SRS resource set includes multiple DL pathloss reference RSs and multiple alpha values, the power headroom (e.g., PH_{type3,b,f,c}(i, qₛ)) may be determined as:

$${PH}_{type 3 , b , f , c} ( i , {q}_{s} ) = {P}_{CMAX , f , c} ( i ) - \{ \begin{matrix}{P}_{{O}_{SRS} , b , f , c} ( {q}_{s} ) + 10 {log}_{10} ( {2}^{μ} {M}_{SRS , b , f , c} ( i ) ) + \\ 10 \cdot {log}_{10} ( {\sum }_{m = 0}^{M - 1} {10}^{{α}_{SRS , b , f , c , m} ( {q}_{s} ) \cdot \frac{{PL}_{b , f , c , m} ( {q}_{d , m} )}{10}} ) + {h}_{b , f , c} ( i , l )\end{matrix} \} [ dBm ] \qquad ( 6 )$$

Parameters in formula (6) may have the same definitions as those in formula (4), except that PL_{b,f,c,m}(q_{d,m}) is represented in linear value.

The above formulae (1)-(6) are only provided for illustrate purpose. Various changes may be made to the above formulae without departing from the spirit and scope of the disclosure.

### Embodiment 1-2

In embodiment 1-2, the power headroom indicated by the single PHR is determined by a transmission power of a reference SRS transmission.

In some examples, the power headroom for a reference SRS transmission may be determined based on power control parameters for an SRS resource set with an SRS resource set ID (e.g., denoted by SRS-ResourceSetId) equal to 0. In such examples, if the SRS resource set with SRS-ResourceSetId=0 is used for DL CSI acquisition for CJT (e.g., the single SRS power control parameter set for the SRS resource set with SRS-ResourceSetId=0 includes multiple DL pathloss reference RSs), the transmission power of a reference SRS transmission may be determined based on the power control parameters included in the single SRS power control parameter set. Otherwise, the power headroom for a reference SRS transmission may be determined based on the formula as specified in TS 38.213.

In some examples, the power headroom for a reference SRS transmission may be determined based on power control parameters for an SRS resource set having a lowest SRS resource set ID among SRS resource sets configured with multiple DL pathloss reference RSs. For example, such examples may apply to a case where the SRS resource set with SRS-ResourceSetId=0 is not used for DL CSI acquisition for CJT.

As one example, the transmission power of a reference SRS transmission may be determined based on an equally weighted combination of multiple pathloss estimates obtained by using (1) either the common alpha value or the multiple alpha values included in the single SRS power control parameter set for an SRS resource set (e.g., the SRS resource set with SRS-ResourceSetId=0 or having a lowest SRS resource set ID among SRS resource sets configured with multiple DL pathloss reference RSs, as described above) and (2) a fixed weight coefficient. Each pathloss estimate in the multiple pathloss estimates may be determined based on a corresponding DL pathloss reference RS in the multiple DL pathloss reference RSs included in the single SRS power control parameter set for the SRS resource set.

For example, the single SRS power control parameter set for an SRS resource set may include multiple DL pathloss reference RSs and multiple alpha values. In such example, if the UE determines that a PHR for an activated serving cell is based on a reference SRS transmission, the UE is not configured for PUSCH transmissions on carrier f of serving cell c and the resource for the reference SRS transmission is in SRS resource set qₛ (e.g., the SRS resource set with SRS-ResourceSetId=0 or having a lowest SRS resource set ID among SRS resource sets configured with multiple DL pathloss reference RSs, as described above), then, for SRS transmission occasion i on active UL BWP b of the carrier f of the serving cell c, the power headroom (e.g., PH_{type3,b,f,c}(i, qₛ)) may be determined as:

$${PH}_{type 3 , b , f , c} ( i , {q}_{s} ) = {\tilde{P}}_{CMAX , f , c} ( i ) - \{ \begin{matrix}{P}_{O\_SRS , b , f , c} ( {q}_{s} ) + \\ {\sum }_{m = 0}^{M - 1} {α}_{SRS , b , f , c , m} ( {q}_{s} ) \cdot {PL}_{b , f , c , m} ( {q}_{d , m} ) / M + {h}_{b , f , c} ( i , l )\end{matrix} \} [ dBm ] \qquad ( 7 )$$

wherein P_{O_SRS,b,f,c}(qₛ) is the Po value included in the single SRS power control parameter set for the SRS resource set qₛ; h_{b,f,c}(i, l) is the close loop state included in the single SRS power control parameter set for the SRS resource set qₛ; \tilde{P}_{CMAX,f,c}(i) is computed assuming MPR=0 dB, A-MPR=0 dB, P-MPR=0 dB and ΔT_{C}=0 dB, wherein MPR, A-MPR, P-MPR and ΔT_{C} may have the same definitions as those specified in TS 38.101; q_{d,m} represents a DL pathloss reference RS, wherein m=0, 1, . . . , M−1 and M is the number of the multiple DL pathloss reference RSs; PL_{b,f,c,m}(q_{d,m}) is a pathloss estimate determined based on a corresponding DL pathloss reference RS q_{d,m}; α_{SRS,b,f,c,m}(qₛ) is an alpha value associated with a corresponding DL pathloss reference RS q_{d,m}; and 1/M is the fixed weight coefficient for multiple pathloss estimates.

As another example, a fixed weight coefficient may be merged into an alpha value. For example, the multiple alpha values may be selected from a set of candidate alpha values. In legacy, a set of candidate alpha values may be {0, 0.4, 0.5, 0.6, 0.7, 0.8, 0.9, 1}. By merging a fixed weight coefficient (e.g., ½ or ⅓), some additional candidate alpha values (e.g., 0.1, 0.2, 0.3) may be obtained from the above set of candidate alpha values (e.g., by multiplying the fixed weight coefficient). The additional candidate alpha values may be added to the above set to form a new set of candidate alpha values, from which the multiple alpha values may be selected.

As another example, the transmission power of a reference SRS transmission may be determined based on a maximum pathloss estimate among multiple pathloss estimates, or determined based on a pathloss estimate calculated based on a fixed DL pathloss reference RS in the multiple DL pathloss reference RSs included in the single SRS power control parameter set for an SRS resource set. Each pathloss estimate in the multiple pathloss estimates is determined based on a corresponding DL pathloss reference RS in the multiple DL pathloss reference RSs included in the single SRS power control parameter set for the SRS resource set. For example, the SRS resource set may have an SRS resource set ID (e.g., SRS-ResourceSetld) equal to 0 or have a lowest SRS resource set ID among SRS resource sets configured with multiple DL pathloss reference RSs

For example, the single SRS power control parameter set for an SRS resource set may include multiple DL pathloss reference RSs and multiple alpha values. Then, the power headroom (e.g., PH_{type3,b,f,c}(i, qₛ)) may be determined as:

$${PH}_{type 3 , b , f , c} ( i , {q}_{s} ) = {\tilde{P}}_{CMAX , f , c} ( i ) - \{ \begin{matrix}{P}_{O\_SRS , b , f , c} ( {q}_{s} ) + \\ {α}_{SRS , b , f , c , \overline{m}} ( {q}_{s} ) \cdot {PL}_{b , f , c , \overline{m}} ( {q}_{d , \overline{m}} ) + {h}_{b , f , c} ( i , l )\end{matrix} \} [ dBm ] \qquad ( 8 )$$

wherein PL_{b,f,c,m̅}(q_{d,m̅}) may be the maximum pathloss estimate among the multiple pathloss estimates which is determined based on a DL pathloss reference RS q_{d,m̅}. Alternatively, PL_{b,f,c,m̅}(q_{d,m̅}) may be a pathloss estimate calculated based on a fixed DL pathloss reference RS (e.g., q_{d,m}) in the multiple DL pathloss reference RSs. For example, q_{d,m̅} may be the value 0 (e.g., the first DL pathloss reference RS in the multiple DL pathloss reference RSs). α_{SRS,b,f,c,m̅}(qₛ) is an alpha value associated with the DL pathloss reference RS q_{d,m̅}; definitions of other parameters in formula (8) may be the same as those in formula (7).

As yet another example, the transmission power of a reference SRS transmission may be determined based on a weighted combination of multiple pathloss estimates obtained by using (1) either the common alpha value or the multiple alpha values and (2) the multiple gamma values included in the single SRS power control parameter set for an SRS resource set. Each pathloss estimate in the multiple pathloss estimates is determined based on a corresponding DL pathloss reference RS in the multiple DL pathloss reference RSs included in the single SRS power control parameter set for the SRS resource set. For example, the SRS resource set may have an SRS resource set ID (e.g., SRS-ResourceSetId) equal to 0 or have a lowest SRS resource set ID (e.g., the first SRS resource set) among SRS resource sets configured with multiple DL pathloss reference RSs

For example, the single SRS power control parameter set for an SRS resource set may include multiple DL pathloss reference RSs, multiple alpha values and multiple gamma values. Then, the power headroom (e.g., PH_{type3,b,f,c}(i, qₛ)) may be determined as:

$${PH}_{type 3 , b , f , c} ( i , {q}_{s} ) = {\tilde{P}}_{CMAX , f , c} ( i ) - \{ \begin{matrix}{P}_{O\_SRS , b , f , c} ( {q}_{s} ) + \\ {\sum }_{m = 0}^{M - 1} {α}_{SRS , b , f , c , m} ( {q}_{s} ) \cdot {PL}_{b , f , c , m} ( {q}_{d , m} ) \cdot {γ}_{SRS , b , f , c , m} ( {q}_{s} ) + {h}_{b , f , c} ( i , l )\end{matrix} \} [ dBm ] \qquad ( 9 )$$

wherein q_{d,m} represents a DL pathloss reference RS, wherein m=0, 1, . . . , M−1 and M is the number of the multiple DL pathloss reference RSS; PL_{b,f,c,m}(q_{d,m}) is a pathloss estimate determined based on a corresponding DL pathloss reference RS q_{d,m}; α_{SRS,b,f,c,m}(qₛ) is an alpha values associated with a corresponding DL pathloss reference RS q_{d,m}, and γ_{SRS,b,f,c,m}(qₛ) is a gamma value associated with a pathloss estimate PL_{b,f,c,m}(q_{d,m}); definitions of other parameters in formula (9) may be the same as those in formula (7).

The above formulae (7)-(9) are only provided for illustrate purpose. Various changes may be made to the above formulae without departing from the spirit and scope of the disclosure.

### Embodiment 2

In embodiment 2, the UE transmits multiple PHRs, each PHR of the multiple PHRs indicates a power headroom determined by a corresponding transmission power of an actual SRS transmission or a reference SRS transmission, and the corresponding transmission power is determined based on a corresponding pathloss estimate which is calculated based on a corresponding DL pathloss reference RS in the multiple DL pathloss reference RSs. Depending on whether the power headroom indicated by each PHR is determined by a transmission power of an actual SRS transmission or a transmission power of a reference SRS transmission, embodiment 2 may include embodiment 2-1 and embodiment 2-2.

### Embodiment 2-1

In embodiment 2-1, the power headroom indicated by each PHR of the multiple PHRs is determined by a corresponding transmission power of an actual SRS transmission, and the corresponding transmission power is determined based on a corresponding pathloss estimate which is calculated based on a corresponding DL pathloss reference RS in the multiple DL pathloss reference RSs included in the single SRS power control parameter set for an SRS resource set.

For example, the single SRS power control parameter set for an SRS resource set may include multiple DL pathloss reference RSs and multiple alpha values. Then a power headroom (e.g., PH_{type3,b,f,c,m}(i, qₛ) indicated by a PHR may be determined as:

$${PH}_{type 3 , b , f , c , m} ( i , {q}_{s} ) = {P}_{CMAX , f , c} ( i ) - \{ \begin{matrix}{P}_{O\_SRS , b , f , c} ( {q}_{s} ) + 10 {log}_{10} ( {2}^{μ} {M}_{SRS , b , f , c} ( i ) ) + \\ {α}_{SRS , b , f , c , m} ( {q}_{s} ) \cdot {PL}_{b , f , c , m} ( {q}_{d , m} ) + {h}_{b , f , c , m} ( i , l )\end{matrix} \} [ dBm ] \qquad ( 10 )$$

Parameters in formula (10) may have the same definitions as those in formula (4).

As shown in formula (10), the UE may determine M power headrooms, and transmit M PHRs to the BS, wherein each PHR may indicate a corresponding power headroom of the M power headrooms.

### Embodiment 2-2

In embodiment 2-2, the power headroom indicated by each PHR of the multiple PHRs is determined by a corresponding transmission power of a reference SRS transmission, and the corresponding transmission power is determined based on a corresponding pathloss estimate which is calculated based on a corresponding DL pathloss reference RS in the multiple DL pathloss reference RSs included in the single SRS power control parameter set for an SRS resource set.

In an embodiment, the SRS resource set may have an SRS resource set ID (e.g., SRS-ResourceSetId) equal to 0. That is, the transmission power of a reference SRS transmission may be determined based on the power control parameters included in the single SRS power control parameter set for the SRS resource set with SRS-ResourceSetId=0. In another embodiment, the SRS resource set may have a lowest SRS resource set ID among SRS resource sets configured with multiple DL pathloss reference RSs. That is, the transmission power of a reference SRS transmission may be determined based on the power control parameters included in the single SRS power control parameter set for the SRS resource set with lowest SRS resource set ID among SRS resource sets configured with multiple DL pathloss reference RSs.

For example, the single SRS power control parameter set for an SRS resource set may include multiple DL pathloss reference RSs and multiple alpha values. Then, a power headroom (e.g., PH_{type3,b,f,c,m}(i, qₛ)) indicated by a PHR may be determined as:

$${PH}_{type 3 , b , f , c , m} ( i , {q}_{s} ) = {\tilde{P}}_{CMAX , f , c} ( i ) - \{ \begin{matrix}{P}_{O\_SRS , b , f , c} ( {q}_{s} ) + \\ {α}_{SRS , b , f , c , m} ( {q}_{s} ) \cdot {PL}_{b , f , c , m} ( {q}_{d , m} ) + {h}_{b , f , c} ( i , l )\end{matrix} \} [ dBm ] \qquad ( 11 )$$

Parameters in formula (11) may have the same definitions as those in formula (9)

As shown in formula (11), the UE may determine M power headrooms, and transmit M PHRs to the BS, wherein each PHR may indicate a corresponding power headroom of the M power headrooms.

The above formulae (10) and (11) are only provided for illustrate purpose. Various changes may be made to the above formulae without departing from the spirit and scope of the disclosure.

### Embodiment 3

In embodiment 3, the UE may transmit two PHRs. One PHR of the two PHRs indicates a first power headroom determined by a first transmission power of an actual SRS transmission or a reference SRS transmission which is determined based on a weighted combination of multiple pathloss estimates obtained by using the at least one of (1) either the common alpha value or the multiple alpha values or (2) the multiple gamma values included in the single SRS power control parameter set for an SRS resource set. Each pathloss estimate in the multiple pathloss estimates is determined based on a corresponding DL pathloss reference RS in the multiple DL pathloss reference RSs included in the single SRS power control parameter set for the SRS resource set. In an embodiment, the weighted combination of the multiple pathloss estimates may be an equally weighted combination of the multiple pathloss estimates obtained by using (1) either the common alpha value or the multiple alpha values and (2) a fixed weight coefficient, e.g., 1/M, wherein M is the number of the multiple DL pathloss reference RSs.

The other PHR of the two PHRs indicates a second power headroom determined by a second transmission power of an actual SRS transmission or a reference SRS transmission which is determined based on a pathloss estimate calculated based on a selected DL pathloss reference RS in the multiple DL pathloss reference RSs.

Depending on whether the first or second power headroom is determined by a transmission power of an actual SRS transmission or a transmission power of a reference SRS transmission, embodiment 3 may include embodiment 3-1 and embodiment 3-2.

### Embodiment 3-1

In embodiment 3-1, the first power headroom is determined by a first transmission power of an actual SRS transmission which is determined based on a weighted combination of the multiple pathloss estimates obtained by using the at least one of (1) either the common alpha value or the multiple alpha values or (2) the multiple gamma values. The specific examples may refer to those described with respect to embodiment 1-1. For example, formulae (1)-(4) may also be used to determine the first power headroom.

In embodiment 3-1, the second power headroom is determined by a second transmission power of an actual SRS transmission which is determined based on a pathloss estimate calculated based on a selected DL pathloss reference RS in the multiple DL pathloss reference RSs. In some embodiments, the selected DL pathloss reference RS may be a first configured DL pathloss reference RS among the multiple DL pathloss reference RSs, or may be associated with a largest pathloss estimate among the multiple DL pathloss reference RSs.

For example, the second power headroom (e.g., PH_{type3,b,f,c,2}(i, qₛ)) may be determined as:

$${PH}_{type 3 , b , f , c , 2} ( i , {q}_{s} ) = {P}_{CMAX , f , c} ( i ) - \{ \begin{matrix}{P}_{{O}_{SRS} , b , f , c} ( {q}_{s} ) + 10 {log}_{10} ( {2}^{μ} {M}_{SRS , b , f , c} ( i ) ) + \\ {α}_{SRS , b , f , c , \overline{m}} ( {q}_{s} ) \cdot {PL}_{b , f , c , \overline{m}} ( {q}_{d , \overline{m}} ) + {h}_{b , f , c} ( i , l )\end{matrix} \} [ dBm ] \qquad ( 12 )$$

wherein q_{d,m̅} represents the selected DL pathloss reference RS in the multiple DL pathloss reference RSs, which may be a first configured DL pathloss reference RS among the multiple DL pathloss reference RSs, or may be associated with a largest pathloss estimate among the multiple DL pathloss reference RSs; PL_{b,f,c,m̅}(q_{d,m̅}) is a pathloss estimate calculated based on the selected DL pathloss reference RS q_{d,m̅}; α_{SRS,b,f,c,m̅}(qₛ) is an alpha value associated with the selected DL pathloss reference RS q_{d,m̅}; other parameters in formula (12) may have the same definitions as those in formula (1).

### Embodiment 3-2

In embodiment 3-2, the first power headroom may be determined by a first transmission power of a reference SRS transmission which is determined based on a weighted combination of the multiple pathloss estimates obtained by using the at least one of (1) either the common alpha value or the multiple alpha values or (2) the multiple gamma values included in the single SRS power control parameter set for an SRS resource set (e.g., with an SRS resource set ID equal to 0 or have a lowest SRS resource set ID among SRS resource sets configured with multiple DL pathloss reference RSs). The specific examples may refer to those described with respect to embodiment 1-2. For example, formulae (7) and (9) may also be used to determine the first power headroom.

In embodiment 3-2, the second power headroom is determined by a second transmission power of a reference transmission which is determined based on a pathloss estimate calculated based on a selected DL pathloss reference RS in the multiple DL pathloss reference RSs. In some embodiments, the selected DL pathloss reference RS may be a first configured DL pathloss reference RS among the multiple DL pathloss reference RSs, or may be associated with a largest pathloss estimate among the multiple DL pathloss reference RSs.

For example, the second power headroom (e.g., PH_{type3,b,f,c,2}(i, qₛ)) may be determined as:

$${PH}_{type 3 , b , f , c , 2} ( i , {q}_{s} ) = {\tilde{P}}_{CMAX , f , c} ( i ) - \{ \begin{matrix}{P}_{O\_SRS , b , f , c} ( {q}_{s} ) + \\ {α}_{SRS , b , f , c , \overline{m}} ( {q}_{s} ) \cdot {PL}_{b , f , c , \overline{m}} ( {q}_{d , \overline{m}} ) + {h}_{b , f , c} ( i , l )\end{matrix} \} [ dBm ] \qquad ( 13 )$$

wherein q_{d,m̅} represents the selected DL pathloss reference RS in the multiple DL pathloss reference RSs, which may be a first configured DL pathloss reference RS among the multiple DL pathloss reference RSs, or may be associated with a largest pathloss estimate among the multiple DL pathloss reference RSs; PL_{b,f,c,m̅}(q_{d,m̅}) is a pathloss estimate calculated based on the selected DL pathloss reference RS q_{d,m̅}; α_{SRS,b,f,c,m̅}(qₛ) is an alpha value associated with the selected DL pathloss reference RS q_{d,m̅}; other parameters in formula (13) may have the same definitions as those in formula (8).

The above formulae (12) and (13) are only provided for illustrate purpose. Various changes may be made to the above formulae without departing from the spirit and scope of the disclosure.

The following embodiments may provide several trigger conditions for triggering transmission of the one or more PHRs in solution 1.

In some embodiments, the UE may trigger transmission of the one or more PHRs when a PHR prohibit timer expires or has expired and a weighted combination of multiple pathloss estimates

$$( e . g . , {\sum }_{m = 0}^{M - 1} {PL}_{b , f , c , m} ( {q}_{d , m} ) \cdot {γ}_{SRS , b , f , c , m} ( {q}_{s} ) )$$

is changed more than a trigger threshold, wherein each pathloss estimate in the multiple pathloss estimates is calculated based on a corresponding DL pathloss reference RS in the multiple DL pathloss reference RSs.

For example, the one or more PHRs may be triggered when a PHR prohibit timer (e.g., phr-ProhibitTimer as specified in 3GPP standard documents) expires or has expired and a weighted combination of the multiple pathloss estimates has changed more than a trigger threshold (e.g., phr-Tx-PowerFactorChange [dB] as specified in 3GPP standard documents) for one activated serving cell of any medium access control (MAC) entity of which the active DL BWP is not dormant BWP since the last transmission of a PHR in this MAC entity when the MAC entity has UL resources for new transmission.

In some embodiments, the UE may trigger transmission of the one or more PHRs when a PHR prohibit timer expires or has expired and a maximum pathloss estimate among multiple pathloss estimates is changed more than a trigger threshold, wherein each pathloss estimate in the multiple pathloss estimates is calculated based on a corresponding DL pathloss reference RS in the multiple DL pathloss reference RSs.

For example, the one or more PHR may be triggered when a PHR prohibit timer (e.g., phr-ProhibitTimer as specified in 3GPP standard documents) expires or has expired and a maximum pathloss estimate (e.g., PL_{b,f,c,m}(q_{d,m})) among the multiple pathloss estimates has changed more than a trigger threshold (e.g., phr-Tx-PowerFactorChange [dB] as specified in 3GPP standard documents) for one activated serving cell of any MAC entity of which the active DL BWP is not dormant BWP since the last transmission of a PHR in this MAC entity when the MAC entity has UL resources for new transmission.

In some embodiments, the UE may trigger transmission of the one or more PHRs when a PHR prohibit timer expires or has expired and a pathloss estimate calculated based on a DL pathloss reference RS in the multiple DL pathloss reference RSs is changed more than a trigger threshold associated with the DL pathloss reference RS. In such embodiments, each of the multiple DL pathloss reference RSs may be associated with a same or different trigger threshold.

For example, the one or more PHR may be triggered when a PHR prohibit timer (e.g., phr-ProhibitTimer as specified in 3GPP standard documents) expires or has expired and any pathloss estimate (e.g., PL_{b,f,c,m}(q_{d,m})) in the multiple pathloss estimates has changed than trigger more a threshold (e.g., phr-Tx-PowerFactorChange [dB] as specified in 3GPP standard documents) for one activated serving cell of any MAC entity of which the active DL BWP is not dormant BWP since the last transmission of a PHR in this MAC entity when the MAC entity has UL resources for new transmission.

In some embodiments, any of the aforementioned trigger thresholds for PHR based on actual SRS transmission may be the same as or different from that for PHR based on reference SRS transmission. If different trigger thresholds are applied, a high priority for getting PHR based on actual SRS transmission or reference SRS transmission may be provided.

### Solution 2

Solution 2 is based on the aforementioned option 2. In solution 2, for each SRS resource set of one or more SRS resource sets, the configuration received in step 201 may include multiple SRS power control parameter sets, wherein each of the multiple SRS power control parameter sets is associated with a corresponding DL pathloss reference RS in multiple DL pathloss reference RSs. For simplicity, the following descriptions take an SRS resource set (e.g., denoted by qₛ) of the one or more SRS resource sets as an example. It is contemplated that the definitions regarding the SRS resource set may also apply to any other SRS resource sets.

For example, the configuration may indicate multiple SRS power control parameter sets for the SRS resource set qₛ. Each of the multiple SRS power control parameter sets may be associated with a corresponding DL pathloss reference RS in the multiple DL pathloss reference RSs. A DL pathloss reference RS may be denoted by q_{d,m}, wherein m is an index of the DL pathloss reference RS and 0≤m≤M−1, wherein M is the total number of the multiple SRS power control parameter sets and also the total number of the multiple DL pathloss reference RSs.

In some embodiments of the present application, each DL pathloss reference RS may be associated with a corresponding TRP. In such embodiments, M is also the total number of TRPs, and m is also an index of a corresponding TRP.

In some embodiments, each SRS power control parameter set may include a corresponding Po value (e.g., denoted by P_{O}_{_{SRS}}_{,b,f,c,m}(qₛ)), a corresponding alpha value (e.g., denoted by α_{SRS,b,f,c,m}(qₛ), and a corresponding closed loop state (e.g., denoted by h_{b,f,c,m}(i, l)), wherein b represents an active UL BWP, f represents a carrier, c represents a serving cell, i represents an SRS transmission occasion, and l represents a power control adjustment state index.

Based on the above configuration, the UE may transmit one or more PHRs in step 203. Depending on the number of PHR(s) transmitted by the UE, solution 2 may include embodiments 1′-3′.

### Embodiment 1′

In embodiment 1′, the UE may transmit a single PHR indicating a power headroom. Depending on whether the power headroom indicated by the single PHR is determined by a transmission power of an actual SRS transmission or a transmission power of a reference SRS transmission, embodiment 1′ may include embodiment 1′-1 and embodiment 1′-2.

### Embodiment 1′-1

In embodiment 1′-1, the power headroom indicated by the single PHR may be determined by a transmission power of an actual SRS transmission. The transmission power may be determined based on a pathloss estimate calculated based on a DL pathloss reference RS associated with an SRS power control parameter set within the multiple SRS power control parameter sets.

For example, if a UE determines that a PHR for an activated serving cell is based on an actual SRS transmission, the UE is not configured for PUSCH transmissions on carrier f of serving cell c and the resource for the SRS transmission is in SRS resource set qₛ, then, for SRS transmission occasion i on active UL BWP b of the carrier f of the serving cell c, the power headroom (e.g., PH_{type3,b,f,c}(i, qₛ)) may be determined as:

$${PH}_{type 3 , b , f , c , m} ( i , {q}_{s} ) = {P}_{CMAX , f , c} ( i ) - \{ \begin{matrix}{P}_{{O}_{SRS} , b , f , c , m} ( {q}_{s} ) + 10 {log}_{10} ( {2}^{μ} {M}_{SRS , f , c} ( i ) ) + \\ {α}_{SRS , b , f , c , m} ( {q}_{s} ) \cdot {PL}_{b , f , c , m} ( {q}_{d , m} ) + {h}_{b , f , c , m} ( i , l )\end{matrix} \} [ dBm ] \qquad ( 14 )$$

wherein q_{d,m} represents a DL pathloss reference RS, wherein m=0, 1, . . . , or M−1; PL_{b,f,c,m}(q_{d,m}) is a pathloss estimate determined based on the DL pathloss reference RS q_{d,m}; P_{O}_{_{SRS}}_{,b,f,c,m}(qₛ), α_{SRS,b,f,c,m}(qₛ), and h_{b,f,c,m}(i, l) are Po value, alpha value, and close loop state respectively, which are included in an SRS power control parameter set associated with the DL pathloss reference RS q_{d,m}; P_{CMAX,f,c}(i), μ, and M_{SRS,bf,c}(i) may have the same definitions as those specified in TS 38.213. How to select the DL pathloss reference RS q_{d,m} for determining the power headroom will be described later.

### Embodiment 1′-2

In embodiment 1′-2, the power headroom indicated by the single PHR may be determined by a transmission power of a reference SRS transmission.

In some examples, the power headroom for a reference SRS transmission may be determined based on power control parameters for an SRS resource set with an SRS resource set ID (e.g., denoted by SRS-ResourceSetId) equal to 0. In such examples, if the SRS resource set with SRS-ResourceSetId=0 is used for DL CSI acquisition for CJT (e.g., the SRS resource set with SRS-ResourceSetId=0 is configured with multiple SRS power control parameter sets), the transmission power of a reference SRS transmission may be determined based on a pathloss estimate calculated based on a DL pathloss reference RS associated with an SRS power control parameter set within the multiple SRS power control parameter sets. Otherwise, the power headroom for a reference SRS transmission may be determined based on the formula as specified in TS 38.213.

In some examples, the power headroom for a reference SRS transmission may be determined based on power control parameters for an SRS resource set having a lowest SRS resource set ID among SRS resource sets configured with multiple DL pathloss reference RSs. For example, such examples may apply to a case where the SRS resource set with SRS-ResourceSetId=0 is not used for DL CSI acquisition for CJT.

As one example, the transmission power of a reference SRS transmission may be determined based on a pathloss estimate calculated based on a DL pathloss reference RS associated with an SRS power control parameter set within the multiple SRS power control parameter sets for an SRS resource set, wherein the SRS resource set may have an SRS resource set ID (e.g., SRS-ResourceSetId) equal to 0 or have a lowest SRS resource set ID (e.g., the first SRS resource set) among SRS resource sets configured with multiple SRS power control parameter sets.

In such example, if the UE determines that a PHR for an activated serving cell is based on a reference SRS transmission, the UE is not configured for PUSCH transmissions on carrier f of serving cell c and the resource for the reference SRS transmission is in SRS resource set qₛ (e.g., the SRS resource set with SRS-ResourceSetId=0 or having a lowest SRS resource set ID among SRS resource sets configured with multiple DL pathloss reference RSs, as described above), then, for SRS transmission occasion i on active UL BWP b of the carrier f of the serving cell c, the power headroom (e.g., PH_{type3,b,f,c}(i, qₛ)) may be determined as:

$${PH}_{type 3 , b , f , c , m} ( i , {q}_{s} ) = {\tilde{P}}_{CMAX , f , c} ( i ) - \{ \begin{matrix}{P}_{{O}_{SRS} , b , f , c , m} ( {q}_{s} ) + \\ {α}_{SRS , b , f , c , m} ( {q}_{s} ) \cdot {PL}_{b , f , c , m} ( {q}_{d , m} ) + {h}_{b , f , c , m} ( i , l )\end{matrix} \} [ dBm ] \qquad ( 15 )$$

wherein q_{d,m} represents a DL pathloss reference RS, wherein m=0, 1, . . . , or M−1; PL_{b,f,c,m}(q_{d,m}) is a pathloss estimate determined based on the DL pathloss reference RS q_{d,m}; P_{O}_{_{SRS}}_{,b,f,c,m}(qₛ), α_{SRS,b,f,c,m}(qₛ), and h_{b,f,c,m}(i, l) are Po value, alpha value, and close loop state respectively, which are included in an SRS power control parameter set associated with the DL pathloss reference RS q_{d,m}; \tilde{P}_{CMAX,f,c}(i) is computed assuming MPR=0 dB, A-MPR=0 dB, P-MPR-0 dB and ΔT_{C}=0 dB, wherein MPR, A-MPR, P-MPR and ΔT_{C} may have the same definitions as those specified in TS 38.101.

The above formulae (14) and (15) are only provided for illustrate purpose. Various changes may be made to the above formulae without departing from the spirit and scope of the disclosure.

In embodiments 1′-1 and 1′-2, how to select the DL pathloss reference RS q_{d,m} for determining the power headroom needs to be solved.

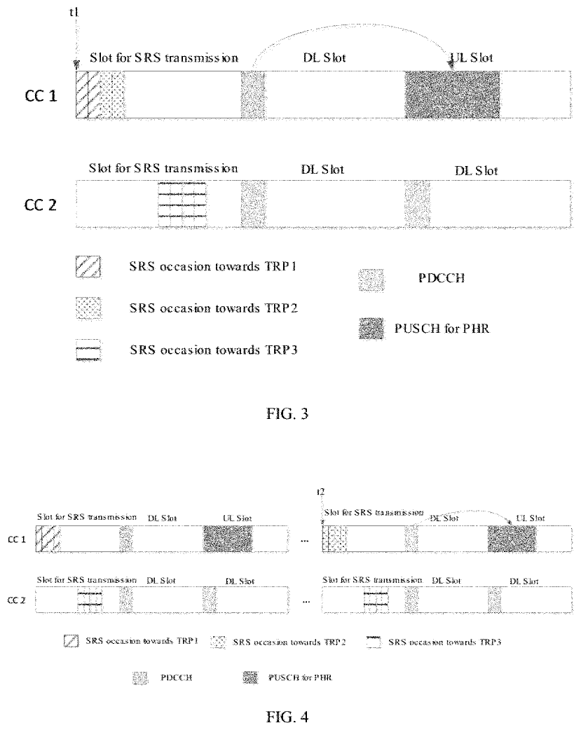

FIGS. 3 and 4 illustrate exemplary SRS transmission for multiple TRPs and SRS PHR reporting according to some embodiments of the present application. In FIGS. 3 and 4, two serving cells (e.g., CC1 and CC2) may be used for SRS transmission.

Referring to FIG. 3, it is assumed that PHR is triggered at t1.

After the power headroom report is triggered, on CC1, the UE may transmit SRS transmission towards TRP1 which is associated with a power control parameter set 1 in two SRS occasions in a slot for SRS transmission, and transmit SRS transmission towards TRP2 which is associated with a power control parameter set 2 in the next two SRS occasions in the slot for SRS transmission; on CC2, the UE may transmit SRS transmission towards TRP3 which is associated with a power control parameter set 3 in four SRS occasions in a slot for SRS transmission. Moreover, after the PHR is triggered, a physical downlink control channel (PDCCH) in a DL slot on CC1 may seclude a PUSCH for reporting power headroom.

In such cases, after the PHR is triggered, the UE may obtain multiple power headrooms based on power control parameter sets 1, 2, and 3. However, the UE only reports a single PHR indicating a power headroom. Then, which power headroom is indicated by the single PHR needs to be determined.

Referring to FIG. 4, it is assumed that PHR is triggered at t2.

Before the PHR is triggered, on CC1, the UE may transmit SRS transmission towards TRP1 which is associated with a power control parameter set 1 in four SRS occasions in a slot for SRS transmission; on CC2, the UE may transmit SRS transmission towards TRP3 which is associated with a power control parameter set 3 in four SRS occasions in a slot for SRS transmission.

After the PHR is triggered, on CC1, the UE may transmit SRS transmission towards TRP2 which is associated with a power control parameter set 2 in four SRS occasions in a slot for SRS transmission; on CC2, the UE may transmit SRS transmission towards TRP3 which is associated with the power control parameter set 3 in four SRS occasions in a slot for SRS transmission.

Moreover, after the PHR is triggered, a PDCCH in a DL slot on CC1 may seclude a PUSCH for reporting power headroom.

In such cases, after the PHR is triggered, the UE may obtain multiple power headrooms based on power control parameter sets 2 and 3. However, the UE only reports a single PHR indicating a power headroom. Then, which power headroom is indicated by the single PHR needs to be determined.

According to some embodiments of the present application, the SRS power control parameter set for determining a power headroom indicated by a single PHR may have a fixed index within the multiple SRS power control parameter sets for an SRS resource set (e.g., the SRS resource set may be the one used for the actual SRS transmission in embodiment 1′-1, and may be the one with SRS-ResourceSetId=0 or with a lowest SRS resource set ID among SRS resource sets configured with multiple SRS power control parameter sets in embodiment 1′-2). For example, the fixed index may be index 0, which corresponds to the first SRS power control parameter set within the multiple SRS power control parameter sets. Such embodiments may work well for the case shown in FIG. 3. However, for the case shown in FIG. 4, PHR can only indicate a power headroom determined based on a reference SRS transmission because there is no actual SRS transmission associated with the first SRS power control parameter set after the PHR is triggered.

According to some embodiments of the present application, the SRS power control parameter set for determining a power headroom indicated by a single PHR may be a power control parameter set associated with a first actual SRS transmission if there is actual SRS transmission(s) after the PHR is triggered. Otherwise, if there is no actual SRS transmission after the PHR is triggered, the SRS power control parameter set for determining a power headroom indicated by a single PHR may be the first power control parameter set associated with a reference SRS transmission.

According to some embodiments of the present application, the SRS power control parameter set for determining a power headroom indicated by a single PHR may be a power control parameter set selected by the UE.

In some embodiments, the UE may transmit an indication indicating the selected power control parameter set to a BS. In an embodiment, the indication may be included in a PHR MAC control element (CE) (e.g., a multiple entry PHR MAC CE). In an embodiment, the indication may indicate an index of the selected power control parameter set. For example, assuming that the multiple power control parameter sets are two power control parameter sets, the indication may be a 1-bit indication, wherein value “0” indicates one power control parameter set and value “1” indicates the other power control parameter set. As another example, assuming that the multiple power control parameter sets are three or four power control parameter sets, the indication may be a 2-bit indication, and each value of the indication indicates a corresponding power control parameter set.

In some examples, the selected power control parameter set may be the first SRS power control parameter set in SRS power control parameter set(s) associated with actual SRS transmission(s) if the actual SRS transmission(s) exists or may have an index 0 in SRS power control parameter set(s) associated with reference SRS transmission(s) if there is no actual SRS transmission(s).

In some examples, the selected power control parameter set may be associated with a largest measured pathloss.

### Embodiment 2′

In embodiment 2′, the UE may transmit one or more PHRs, and each PHR may indicate a corresponding power headroom determined by a corresponding transmission power of an actual SRS transmission or a reference SRS transmission, wherein the corresponding transmission power is determined based on a corresponding pathloss estimate which is associated with a corresponding SRS power control parameter set in the multiple SRS power control parameter sets for an SRS resource set. In other words, each PHR is associated with a corresponding SRS power control parameter set in the multiple SRS power control parameter sets, and thus associated with a corresponding DL pathloss reference RS q_{d,m}, wherein m=0, 1, . . . , or M−1. Since there is M DL pathloss reference RS q_{d,m}, there is M possible PHRs, and the one or more PHRs may be part or all of the M possible PHRs.

In some embodiments, in the case that the transmission power associated with a PHR to be transmitted is determined based on an actual SRS transmission, the corresponding power headroom may be determined using the method described in embodiment 1′-1, e.g., using formula (14); in the case that the transmission power associated with a PHR to be transmitted is determined based on a reference SRS transmission, the corresponding power headroom may be determined using the method described in embodiment 1′-2, e.g., using formula (15).

In some embodiments, the number of the one or more PHRs transmitted by the UE in once reporting is fixed to M, which is the number of the multiple SRS power control parameter sets and also the number of the multiple DL pathloss reference RSs. That is, all of the M possible PHRs are transmitted. In an embodiment, M may be a pre-defined value. In another embodiment, M may be configured by the BS.

In some embodiments, the one or more PHRs transmitted by the UE are selected by the UE from the M possible PHRs according to a trigger condition, which will be described later.

In such embodiments, the UE may transmit an indication indicating index(es) of the one or more PHRs to the BS, for example, the index(es) of the one or more PHRs may be index(es) of the one or more PHRs among the M possible PHRs. In an embodiment, the indication may be included in a PHR MAC CE (e.g., an enhanced multiple entry PHR for multiple TRP MAC CE). In an embodiment, the indication may be a bitmap, wherein each bit in the bitmap corresponding to a PHR of the M possible PHRs and indicates whether the PHR is transmitted to the BS.

In an embodiment, the UE may receive an indication indicating a maximum number of PHRs to be transmitted in once reporting from the BS. For example, the maximum number may be any number no greater than M. The UE may transmit the one or more PHRs based on the maximum number of PHRs configured by the BS.

The following embodiments may provide several trigger conditions for triggering transmission of the one or more PHRs in solution 2.

In the case that the UE only transmits a single PHR (e.g., embodiment 1′), the UE may trigger transmission of the single PHR when a PHR prohibit timer expires or has expired and a pathloss estimate determined based on a DL pathloss reference RS associated with an SRS power control parameter set within the multiple SRS power control parameter sets is changed more than a trigger threshold associated with the SRS power control parameter set. In such embodiments, the SRS power control parameter set may be any SRS power control parameter set within the multiple SRS power control parameter sets. Each of the multiple SRS power control parameter sets may be associated with a same or different trigger threshold.

For example, the single PHR may be triggered when a PHR prohibit timer (e.g., phr-ProhibitTimer as specified in 3GPP standard documents) expires or has expired and a pathloss estimate determined based on a DL pathloss reference RS associated with an SRS power control parameter set has changed more than a trigger threshold (e.g., phr-Tx-PowerFactorChange [dB] as specified in 3GPP standard documents) for one activated serving cell of any MAC entity of which the active DL BWP is not dormant BWP since the last transmission of a PHR in this MAC entity when the MAC entity has UL resources for new transmission.

In the case that the UE only transmits a single PHR (e.g., embodiment 1′), the UE may trigger transmission of the single PHR when a PHR prohibit timer expires or has expired and a pathloss estimate determined based on a DL pathloss reference RS associated with an SRS power control parameter set with a fixed index within the multiple SRS power control parameter sets is changed more than a trigger threshold.

For example, the single PHR may be triggered when a PHR prohibit timer (e.g., phr-ProhibitTimer as specified in 3GPP standard documents) expires or has expired and a pathloss estimate determined based on a DL pathloss reference RS associated with an SRS power control parameter set with a fixed index (e.g., 0) has changed more than a trigger threshold (e.g., phr-Tx-PowerFactorChange [dB] as specified in 3GPP standard documents) for one activated serving cell of any MAC entity of which the active DL BWP is not dormant BWP since the last transmission of a PHR in this MAC entity when the MAC entity has UL resources for new transmission.

In the case that the UE may transmit one or more PHRs (e.g., embodiment 2′), the UE may triggers transmission of the one or more PHRs when a PHR prohibit timer expires or has expired and a pathloss estimate determined based on a DL pathloss reference RS associated with an SRS power control parameter set within the multiple SRS power control parameter sets is changed more than a trigger threshold associated with the SRS power control parameter set. In such embodiments, the SRS power control parameter set may be any SRS power control parameter set within the multiple SRS power control parameter sets. Each of the multiple SRS power control parameter sets may be associated with a same or different trigger threshold.

For example, the one or more PHR may be trigger when a PHR prohibit timer (e.g., phr-ProhibitTimer as specified in 3GPP standard documents) expires or has expired and a pathloss estimate determined based on a DL pathloss reference RS associated with an SRS power control parameter set has changed more than a trigger threshold (e.g., phr-Tx-PowerFactorChange dB as specified in 3GPP standard documents) for one activated serving cell of any MAC entity of which the active DL BWP is not dormant BWP since the last transmission of a PHR in this MAC entity when the MAC entity has UL resources for new transmission.

As one example, when a PHR prohibit timer expires or has expired and a pathloss estimate determined based on a DL pathloss reference RS associated with any SRS power control parameter set within the multiple SRS power control parameter sets is changed more than a trigger threshold associated with the SRS power control parameter set, all of the M possible PHRs are triggered to be transmitted. As another example, when a PHR prohibit timer expires or has expired and a pathloss estimate determined based on a DL pathloss reference RS associated with a particular SRS power control parameter set is changed more than a trigger threshold associated with the particular SRS power control parameter set, only the PHR associated with the particular SRS power control parameter set is triggered to be transmitted. By setting different thresholds for different SRS power control parameter sets, a high priority for getting PHR based on specific SRS power control parameter sets may be provided.

In some embodiments, the trigger threshold for PHR based on actual SRS transmission may be the same as or different from that for PHR based on reference SRS transmission. If different trigger thresholds are applied, a high priority for getting PHR based on actual SRS transmission or reference SRS transmission may be provided.

According to some embodiments of the present application, in the case that the UE transmits multiple PHRs, each of PHR(s) other than a first PHR in the multiple PHRs indicates a differential quantized power headroom relative to a power headroom (e.g., referred to as a base power headroom) indicated by the first PHR.

For example, in legacy PHR reporting, 6 bits indicating 64 power headroom levels are used with 1 dB quantization precision for quantization range [−32, 22] dB and 2 dB quantization precision for quantization range [22, 38] dB.

When differential quantization is used for PHR reporting, 1 bit may be used to indicate positive or negative differential value and 4 bits may be used to indicate [0, 15] dB differential power headroom value with 1 dB quantization precision, and thus the total number of PHR reporting bits may be reduced to 5 bits. For example, assuming that three power headrooms respectively equal to 0 dB, −4 dB, and 6 dB may be reported to the BS, the UE may transmit three PHRs (e.g., denoted by PHR 1, PHR 2, and PHR 3), the first PHR (i.e., PHR 1) may be “00000” indicating an absolute quantized power headroom equal to 0 dB; PHR 2 may be “10100,” wherein the first bit “1” indicates a negative differential value and the subsequent four bits “0100” indicates a differential quantized power headroom (e.g., 4 dB) relative to 0 dB; PHR 3 may be “00110,” wherein the first bit “1” indicates a positive differential value and the subsequent four bits “0110” indicates a differential quantized power headroom (e.g., 6 dB) relative to 0 dB.

Differential quantized power headroom can be used for multiple PHR reporting schemes as provided in above solution 1 and multiple PHR reporting schemes as provided in above solution 2.

FIG. 5 is a flow chart illustrating an exemplary method for SRS PHR according to some other embodiments of the present application. The method illustrated in FIG. 5 may be implemented by a BS (e.g., BS 101 as shown in FIG. 1) or any other device having similar functions.

In the exemplary method shown in FIG. 5, in step 501, the BS may transmit configuration for SRS power control to a UE (e.g., UE 105 as shown in FIG. 1). In step 503, the BS may receive one or more PHRs from the UE based on the configuration. It is contemplated that the operations of the BS may correspond to those of the UE which are described with respect to FIG. 2. All the definitions and operations related to the configuration and the one or more PHRs described in the above solutions and embodiments may also apply here. Thus, details are omitted for simplicity.

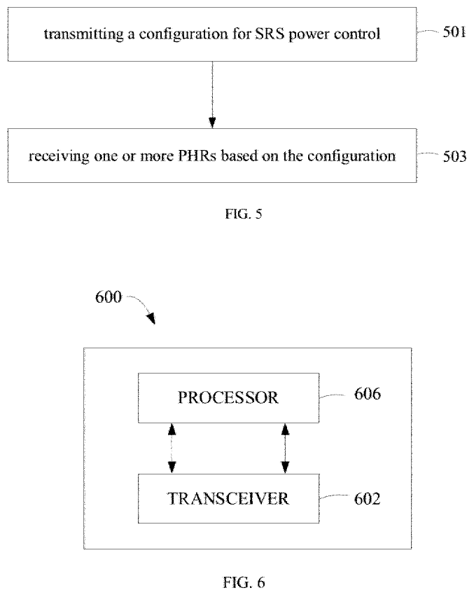

FIG. 6 illustrates a simplified block diagram of an exemplary apparatus 600 for SRS PHR according to some embodiments of the present application. In some embodiments, the apparatus 600 may be or include at least part of a UE (e.g., UE 105 in FIG. 1). In some other embodiments, the apparatus 600 may be or include at least part of a BS (e.g., BS 101 in FIG. 1).

Referring to FIG. 6, the apparatus 600 may include at least one transceiver 602 and at least one processor 606. The at least one transceiver 602 is coupled to the at least one processor 606.

Although in this figure, elements such as the transceiver 602 and the processor 606 are illustrated in the singular, the plural is contemplated unless a limitation to the singular is explicitly stated. In some embodiments of the present application, the transceiver 602 may be divided into two devices, such as receiving circuitry (or a receiver) and transmitting circuitry (or a transmitter). In some embodiments of the present application, the apparatus 600 may further include an input device, a memory, and/or other components. The transceiver 602 and the processor 606 may be configured to perform any of the methods described herein (e.g., the methods described with respect to FIGS. 2-5 or other methods described in the embodiments of the present application).

According to some embodiments of the present application, the apparatus 600 may be a UE, and the transceiver 602 and the processor 606 may be configured to perform operations of a UE in any of the methods as described with respect to FIGS. 2-4 or other methods described in the embodiments of the present application. For example, the transceiver 602 may: receive a configuration for SRS power control, wherein the configuration indicates one of: a single SRS power control parameter set for an SRS resource set, wherein the single SRS power control parameter set includes multiple DL pathloss reference RSs; or multiple SRS power control parameter sets for the SRS resource set, wherein each of the multiple SRS power control parameter sets is associated with a corresponding DL pathloss reference RS in the multiple DL pathloss reference RSs; and transmit one or more PHRs based on the configuration.

According to some embodiments of the present application, the apparatus 600 may be a BS, and the transceiver 602 and the processor 606 may be configured to perform operations of a BS in any of the methods as described with respect to FIGS. 3-5 or other methods described in the embodiments of the present application. For example, the transceiver 602 may: transmit, to a UE, a configuration for SRS power control, wherein the configuration indicates one of: a single SRS power control parameter set for an SRS resource set, wherein the single SRS power control parameter set includes multiple DL pathloss reference RSs; or multiple SRS power control parameter sets for the SRS resource set, wherein each of the multiple SRS power control parameter sets is associated with a corresponding DL pathloss reference RS in the multiple DL pathloss reference RSs; and receive, from the UE, one or more PHRs based on the configuration.

In some embodiments of the present application, the apparatus 600 may further include at least one non-transitory computer-readable medium. In some embodiments of the present disclosure, the non-transitory computer-readable medium may have stored thereon computer-executable instructions to cause the processor 606 to implement any of the methods as described above. For example, the computer-executable instructions, when executed, may cause the processor 606 to interact with the transceiver 602, so as to perform operations of the methods, e.g., as described with respect to FIGS. 2-5 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for SRS PHR, including a processor and a memory. Computer programmable instructions for implementing a method for SRS PHR are stored in the memory, and the processor is configured to perform the computer programmable instructions to implement the method for SRS PHR. The method for SRS PHR may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SRS PHR according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1-15. (canceled)

16. A user equipment (UE) for wireless communication, comprising:
at least one memory; and
at least one processor coupled with the at least one memory and operable to cause the UE to:
receive a configuration for sounding reference signal (SRS) power control, wherein the configuration indicates one of:
an SRS power control parameter set for an SRS resource set, wherein the SRS power control parameter set includes multiple downlink (DL) pathloss reference reference signals (RSs); or
multiple SRS power control parameter sets for the SRS resource set, wherein each of the multiple SRS power control parameter sets is associated with a corresponding DL pathloss reference RS in the multiple DL pathloss reference RSs; and
transmit one or more power headroom reports (PHRs) based at least in part on the configuration.

17. The UE of claim 16, wherein the SRS power control parameter set further includes at least one of:
a common alpha value comprising a common pathloss compensation factor for the multiple DL pathloss reference RSs or multiple alpha values, wherein each alpha value in the multiple alpha values comprises a pathloss compensation factor associated with a corresponding DL pathloss reference RS in the multiple DL pathloss reference RSs; or
multiple gamma values, wherein the multiple gamma values comprise weight coefficients for combining multiple pathloss estimates, and each gamma value in the multiple gamma values is associated with a corresponding pathloss estimate in the multiple pathloss estimates determined based at least in part on a corresponding DL pathloss reference RS in the multiple DL pathloss reference RSs.

18. The UE of claim 17, wherein the at least one processor is operable to cause the UE to:
transmit a PHR indicating a power headroom determined by a transmission power of an SRS transmission, wherein the transmission power of the SRS transmission is determined based on a weighted combination of the multiple pathloss estimates, wherein the weighted combination of the multiple pathloss estimates is obtained by using the at least one of:
either the common alpha value or the multiple alpha values or the multiple gamma values; or
the weighted combination of the multiple pathloss estimates comprises an equally weighted combination of the multiple pathloss estimates obtained by using the common alpha value or the multiple alpha values and a fixed weight coefficient; or
transmit a single PHR indicating a power headroom determined by a transmission power of a reference SRS transmission, wherein the transmission power of the reference SRS transmission is determined based at least in part on an equally weighted combination of the multiple pathloss estimates obtained by using the common alpha value, or the multiple alpha values and a fixed weight coefficient.

19. The UE of claim 17, wherein the at least one processor is operable to cause the UE to:
transmit a PHR indicating a power headroom determined by a transmission power of a reference SRS transmission, wherein the transmission power is determined based at least in part on:
a maximum pathloss estimate among the multiple pathloss estimates;
a pathloss estimate calculated based on a fixed DL pathloss reference RS in the multiple DL pathloss reference RSs; or
a weighted combination of the multiple pathloss estimates obtained by using the common alpha value or the multiple alpha values, and the multiple gamma values.

20. The UE of claim 19, wherein based at least in part on a PHR indicating the power headroom determined by the transmission power of the reference SRS transmission, the SRS resource set comprises an SRS resource set identity (ID) equal to 0 or has a lowest SRS resource set ID among SRS resource sets configured with multiple DL pathloss reference RSs.

21. The UE of claim 16, wherein the at least one processor is operable to cause the UE to:
transmit a PHR indicating a power headroom determined by a transmission power of an SRS transmission or a reference SRS transmission, and the transmission power is determined based on a pathloss estimate calculated based on a DL pathloss reference RS associated with an SRS power control parameter set within the multiple SRS power control parameter sets.

22. The UE of claim 21, wherein:
the SRS power control parameter set has a fixed index within the multiple SRS power control parameter sets;
the SRS power control parameter set comprises a power control parameter set associated with a first actual SRS transmission based at least in part on SRS transmission triggered after the PHR; or
the SRS power control parameter set comprises a power control parameter set selected by the UE, and the at least one processor is operable to cause the UE to transmit an indication indicating the selected power control parameter set to a base station (BS).

23. The UE of claim 16, wherein the at least one processor is operable to cause the UE to:
transmit multiple PHRs, wherein each PHR of the multiple PHRs indicates a power headroom determined by a corresponding transmission power of an SRS transmission or a reference SRS transmission, and the corresponding transmission power is determined based on a corresponding pathloss estimate which is calculated based on a corresponding DL pathloss reference RS in the multiple DL pathloss reference RSs.

24. The UE of claim 16, wherein:
one or more power headrooms are selected from M power headrooms, M comprises a number of the multiple SRS power control parameter sets, each power headroom of the M power headrooms is determined by a corresponding transmission power of an actual SRS transmission or a reference SRS transmission, and a corresponding transmission power is determined based on a corresponding pathloss estimate which is associated with a corresponding SRS power control parameter set in the multiple SRS power control parameter sets;
each PHR of the one or more PHRs indicates a corresponding power headroom in the one or more power headrooms; and
the at least one processor is operable to cause the UE to transmit an indication indicating one or more indexes of the one or more PHRs to a base station (BS).

25. The UE of claim 16, wherein the at least one processor is operable to cause the UE to:
transmit M PHRs, wherein M comprises a number of the multiple SRS power control parameter sets, each PHR of the M PHRs indicates a corresponding power headroom determined by a corresponding transmission power of an SRS transmission or a reference SRS transmission, and the corresponding transmission power is determined based at least in part on a corresponding pathloss estimate associated with a corresponding SRS power control parameter set in the multiple SRS power control parameter sets, wherein M comprises a pre-defined value or is configured by a base station (BS).

26. The UE of claim 16, wherein in a case that the configuration indicates the SRS power control parameter set, transmission of the one or more PHRs is triggered when a PHR prohibit timer expires or has expired and one or more of:
a weighted combination of multiple pathloss estimates is changed more than a trigger threshold, wherein each pathloss estimate in the multiple pathloss estimates is calculated based on a corresponding DL pathloss reference RS in the multiple DL pathloss reference RSs;
a maximum pathloss estimate among the multiple pathloss estimates is changed more than a trigger threshold; or
a pathloss estimate calculated based on a DL pathloss reference RS in the multiple DL pathloss reference RSs is changed more than a trigger threshold associated with the DL pathloss reference RS.

27. The UE of claim 16, wherein in a case that the configuration indicates the multiple SRS power control parameter sets:
transmission of the one or more PHRs is triggered when a PHR prohibit timer expires or has expired and a pathloss estimate determined based on a DL pathloss reference RS associated with an SRS power control parameter set within the multiple SRS power control parameter sets is changed more than a trigger threshold associated with the SRS power control parameter set; or
transmission of a PHR is triggered when a PHR prohibit timer expires or has expired and a pathloss estimate determined based on a DL pathloss reference RS associated with an SRS power control parameter set with a fixed index within the multiple SRS power control parameter sets is changed more than a trigger threshold.

28. The UE of claim 27, wherein each of the multiple DL pathloss reference RSs is associated with a same trigger threshold or a different trigger threshold, or each of the multiple SRS power control parameter sets is associated with a same trigger threshold or a different trigger threshold.

29. A method performed by a user equipment (UE), the method comprising:
receiving a configuration for sounding reference signal (SRS) power control, wherein the configuration indicates one of:
an SRS power control parameter set for an SRS resource set, wherein the SRS power control parameter set includes multiple downlink (DL) pathloss reference reference signals (RSs); or
multiple SRS power control parameter sets for the SRS resource set, wherein each of the multiple SRS power control parameter sets is associated with a corresponding DL pathloss reference RS in the multiple DL pathloss reference RSs; and
transmitting one or more power headroom reports (PHRs) based at least in part on the configuration.

30. The method of claim 29, wherein the SRS power control parameter set further includes at least one of:
a common alpha value comprising a common pathloss compensation factor for the multiple DL pathloss reference RSs or multiple alpha values, wherein each alpha value in the multiple alpha values comprises a pathloss compensation factor associated with a corresponding DL pathloss reference RS in the multiple DL pathloss reference RSs; or
multiple gamma values, wherein the multiple gamma values comprise weight coefficients for combining multiple pathloss estimates, and each gamma value in the multiple gamma values is associated with a corresponding pathloss estimate in the multiple pathloss estimates determined based at least in part on a corresponding DL pathloss reference RS in the multiple DL pathloss reference RSs.

31. The method of claim 30, further comprising:
transmitting a PHR indicating a power headroom determined by a transmission power of an SRS transmission, wherein the transmission power of the SRS transmission is determined based on a weighted combination of the multiple pathloss estimates, wherein the weighted combination of the multiple pathloss estimates is obtained by using the at least one of:
either the common alpha value or the multiple alpha values or the multiple gamma values; or
the weighted combination of the multiple pathloss estimates comprises an equally weighted combination of the multiple pathloss estimates obtained by using the common alpha value or the multiple alpha values and a fixed weight coefficient; or
transmitting a single PHR indicating a power headroom determined by a transmission power of a reference SRS transmission, wherein the transmission power of the reference SRS transmission is determined based at least in part on an equally weighted combination of the multiple pathloss estimates obtained by using the common alpha value, or the multiple alpha values and a fixed weight coefficient.

32. The method of claim 30, further comprising:
transmitting a PHR indicating a power headroom determined by a transmission power of a reference SRS transmission, wherein the transmission power is determined based at least in part on:
a maximum pathloss estimate among the multiple pathloss estimates;
a pathloss estimate calculated based on a fixed DL pathloss reference RS in the multiple DL pathloss reference RSs; or
a weighted combination of the multiple pathloss estimates obtained by using the common alpha value or the multiple alpha values, and the multiple gamma values.

33. The method of claim 32, wherein based at least in part on a PHR indicating the power headroom determined by the transmission power of the reference SRS transmission, the SRS resource set comprises an SRS resource set identity (ID) equal to 0 or has a lowest SRS resource set ID among SRS resource sets configured with multiple DL pathloss reference RSs.

34. A base station (BS) for wireless communication, comprising:
at least one memory; and
at least one processor coupled with the at least one memory and operable to cause the BS to:
transmit, to a user equipment (UE), a configuration for sounding reference signal (SRS) power control, wherein the configuration indicates one of:
an SRS power control parameter set for an SRS resource set, wherein the SRS power control parameter set includes multiple downlink (DL) pathloss reference reference signals (RSs); or
multiple SRS power control parameter sets for the SRS resource set, wherein each of the multiple SRS power control parameter sets is associated with a corresponding DL pathloss reference RS in the multiple DL pathloss reference RSs; and
receive, from the UE, one or more power headroom reports (PHRs) based on the configuration.

35. A method performed by a base station (BS), the method comprising:
transmitting, to a user equipment (UE), a configuration for sounding reference signal (SRS) power control, wherein the configuration indicates one of:
an SRS power control parameter set for an SRS re source set, wherein the SRS power control parameter set includes multiple downlink (DL) pathloss reference reference signals (RSs); or
multiple SRS power control parameter sets for the SRS resource set, wherein each of the multiple SRS power control parameter sets is associated with a corresponding DL pathloss reference RS in the multiple DL pathloss reference RSs; and
receiving, from the UE, one or more power headroom reports (PHRs) based on the configuration.
